(19) United States
(12) Patent Application Publication
(10) Pub. No.: US 2025/0385249 A1
(43) Pub. Date: Dec. 18, 2025

(54) LCO@OXIDE@CNT MULTICOMPOSITE CATHODE MATERIAL

(71) Applicant: Shenzhen TXD Technology Co., Ltd, Shenzhen (CN)

(72) Inventor: ZHI FENG LUO, Shenzhen (CN)

(73) Assignee: Shenzhen TXD Technology Co., Ltd, Shenzhen (CN)

(21) Appl. No.: 18/740,548

(22) Filed: Jun. 12, 2024

(51) Int. Cl. H01M 4/36; C01G 51/00; H01M 4/485; H01M 4/525; H01M 4/62

(52) U.S. Cl. CPC H01M 4/366; C01G 51/42; H01M 4/485; H01M 4/525; H01M 4/625; C01P 2002/50; C01P 2004/61; C01P 2004/84; C01P 2006/40

(57) ABSTRACT

A LCO@oxide@CNT multicomposite cathode material which is a plurality of positive particles. Each of the positive particles comprises a composite LCO particle. The composite LCO particle includes a large LCO (lithium cobalt oxide, LiCoO₂) particle, and a plurality of large LLZO particles and a plurality of small LLZO particles coated on a surface of the large LCO particle. Each of the large LLZO particles and small LLZO particles is formed by a LLZO (Li₇La₃Zr₂O₁₂) or a LLZO doped with at least one metal. A first LLZO interphase layer is formed between a bottom of each of the large LLZO particles and the large LCO particle. A second LLZO interphase layer is formed between a bottom of each of the small LLZO particles and the large LCO particle. An outer surface of each of the composite LCO particle is wrapped by a plurality of first carbon nanotubes.

### FIELD OF THE INVENTION

The present invention is related to a positive electrode material of a battery, and in particular to a LCO@oxide@CNT multicomposite cathode material.

### BACKGROUND OF THE INVENTION

A typical battery includes a positive electrode and a negative electrode. A cathode of the battery is the positive electrode inside the battery. The positive electrode mainly comprises a positive substrate and a positive slurry layer coated on the positive substrate. The positive slurry layer includes a positive slurry having a binding agent and a plurality of positive particles. The positive particles are mainly used in the positive electrode of general solid-state or semi-solid batteries. Positive particles must be either additionally conductive or electrically conductive in order to allow free electrons to migrate through the positive slurry without consuming too much energy due to internal resistance, which achieves effective conductivity. Therefore, specific conductive materials for regulating the conductivity of positive particles must be taken into account in the manufacturing of positive particles.

Traditionally, the positive particles can be made of LCO (lithium cobalt oxide), LMFP (Lithium Manganese Iron Phosphate), or mixtures thereof, which are distributed within the positive slurry. There are many known techniques to improve the conductivity of lithium ions in the positive particles made of these materials, but it is still considered that the conductivity of lithium batteries is not sufficient for practical use. Therefore, it is necessary to carry out some material modifications to further improve the conductivity of the positive particles.

Based on the experience with battery materials, the applicant of the present invention desires to provide a novel invention that enables the positive electrode of solid-state batteries to have higher electrical capacity and conductivity for further enhancing the performance of the batteries.

### SUMMARY OF THE INVENTION

Accordingly, for improving above mentioned defects in the prior art, the object of the present invention is to provide a LCO@oxide@CNT multicomposite cathode material, wherein the cathode material is a positive electrode material of a positive electrode inside a battery. The surface of the large LCO particles is coated with large and small LLZO particles and a interphase layer to form composite LCO particles, which enhances ionic conductivity and protection. Since electron transferring and ion transferring are interdependent, in order to solve the problem that the ceramic nature of the above oxides reduces a part of conductivity of electrons, the outer side of the composite LCO particles is further wrapped with an electron-conducting dielectric, which is a conductive network consisting of short chain and long chain carbon nanotubes with various lengths. The short chain carbon nanotubes provide capability of transferring short-range electron to conduct electrons for making lithium ion transfer easier, while the long chain carbon nanotubes provide capability of transferring the electron between various large and small LLZO particles, the composite LCO particles, and the other materials in the positive electrode substrate, so as to form a small electron transfer chain to promote transferring of ions, and thus improve transferring of electron and ion throughout the entire positive electrode. The wrapping of the carbon nanotubes and the large and small LLZO particles also makes lithium ions less likely to be blocked on the surface of the positive electrode due to poor transmission, and avoids to be combined with the electrolyte to form lithium consumption products such as SEI (Solid Electrolyte Interface). Therefore, it improves the overall lifespan of positive electrode, that is, the cycling performance. The positive electrode material of the present invention also achieves better multiplication performance with the better transfer chain of the lithium ion and electron. By the improving of the transferring of ion and electron in the positive electrode, the side reaction is decreased and the LLZO particles and the interphase layer provide more protection, so that the overall positive electrode is not easy to react with the electrolyte, and is also not easy to be affected by the side reaction after the electrolyte disintegrates and reacts with the positive electrode under a high voltage. As a result, the present invention improves the voltage resistance performance and enables it to be charged and discharged in a range of 4.7V˜4.9V, and reduces the behavior of high pressure oxygen releasing and gas producing of the positive electrode, which enhances the overall safety.

To achieve above object, the present invention provides a LCO@oxide@CNT multicomposite cathode material, wherein the cathode material is a positive electrode material of a positive electrode inside a battery and the positive electrode material is a plurality of positive particles in a positive electrode used in a solid-state battery or semi-solid battery; and the oxide is a LLZO (lithium lanthanum zirconium oxide, Li₇La₃Zr₂O₁₂) or a LLZO doped with at least one metal; each of the positive particles comprising: a composite LCO particle; the composite LCO particle including: a large LCO (lithium cobalt oxide, LiCoO₂) particle which is a cube having an irregular shape; and a plurality of large LLZO particles and a plurality of small LLZO particles coated on a surface of the large LCO particle; each of the large LLZO particles and the small LLZO particles being formed by a LLZO (lithium lanthanum zirconium oxide, Li₇La₃Zr₂O₁₂) or a LLZO doped with at least one metal; wherein each of the large LLZO particles forms a first protruded portion on a surface of the large LCO particle; a center of the first protruded portion is higher than a flat outer side of the first protruded portion; a first LLZO interphase layer is formed between a bottom of each of the large LLZO particles and the large LCO particle; the first LLZO interphase layer serves to provide guiding channels for lithium ions and to provide a protection for the large LCO particle; wherein each of the small LLZO particles forms a second protruded portion on the surface of the large LCO particle; a center of the second protruded portion is higher than a flat outer side of the second protruded portion; a second LLZO interphase layer is formed between a bottom of each of the small LLZO particles and the large LCO particle; the second LLZO interphase layer serves to provide guiding channels for lithium ions and to provide a protection for the large LCO particle; wherein the large LLZO particles and the small LLZO particles have a higher ion guiding capability than that of the large LCO particle and do not easily produce a side reaction with lithium ions; when the lithium ions pass through the positive electrode, conducting paths of the lithium ions are dispersed by the guiding of the large LLZO particles and the small LLZO particles distributed on the large LCO particle; and wherein each of the large LLZO particles and each of the small LLZO particles and the large LCO particle have a crystal structure, which has a good stability and will not be easily released or dissociated, increasing the battery voltage; wherein an outer surface of each of the composite LCO particle is wrapped by a plurality of first carbon nanotubes; the composite LCO particle is covered by the first carbon nanotubes to form the positive particle.

### BRIEF DESCRIPTION OF THE DRAWINGS

FIG. 1 is a schematic view showing the structure of the present invention.

FIG. 2 is a schematic view showing the embodiment of the present invention.

FIG. 3 is an enlarged schematic view showing the structure of the present invention.

FIG. 4 is another enlarged schematic view showing the structure of the present invention.

FIG. 5 is schematic view showing the wrapping of the short chain carbon nanotubes of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

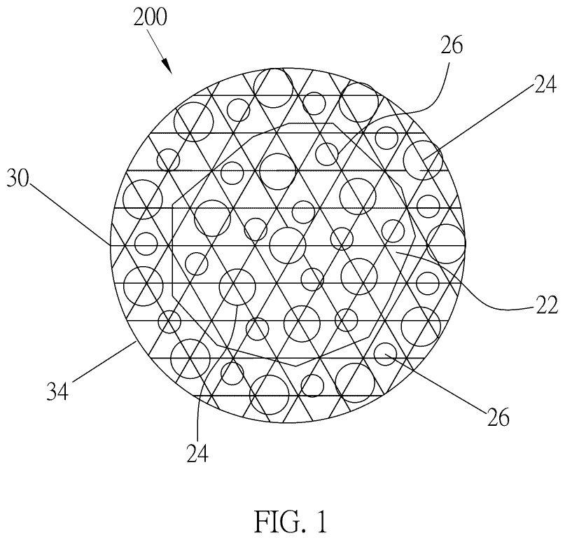

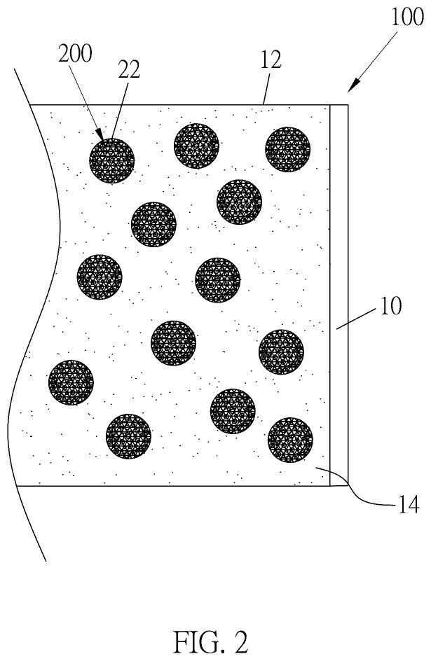

With reference to FIGS. 1 to 5, the present invention provides a LCO@oxide@CNT multicomposite cathode material, wherein the cathode material is a positive electrode material of a positive electrode inside a battery and the positive electrode material is a plurality of positive particles in a positive electrode used in a solid-state battery or semi-solid battery (as shown in FIG. 2). The oxide is a LLZO (lithium lanthanum zirconium oxide, Li₇La₃Zr₂O₁₂) or a LLZO doped with at least one metal. The positive electrode 100 includes a positive substrate 10 and a positive slurry layer 12 coated on the positive substrate 10. The positive slurry layer 12 includes a plurality of positive particles 200 and a positive slurry 14 with a binder. A weight percentage of the plurality of positive particles 200 in the positive slurry layer 12 is 92 wt %˜98 wt %.

Each of the positive particles 200 includes the following elements.

A composite LCO particle 20. The composite LCO particle 20 includes:

A large LCO (lithium cobalt oxide, LiCoO₂) particle 22, which is a cube having an irregular shape. A size of the large LCO particle 22 is 10 μm to 15 μm.

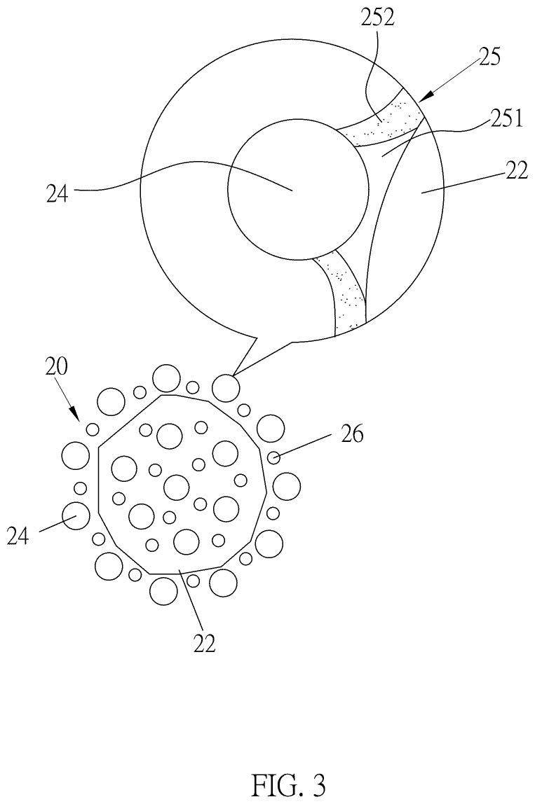

A plurality of large LLZO particles 24 and a plurality of small LLZO particles 26 are coated on a surface of the large LCO particle 22, as shown in FIG. 3. A horizontal size of each of the large LLZO particles 24 is 100 nm˜280 nm, which is a size of the large LLZO particle 24 on a horizontal direction corresponding to a spherical surface of the large LCO particle 22. A horizontal size of each of the small LLZO particles 26 is 50 nm˜100 nm, which is a size of the small LLZO particle on the horizontal direction corresponding to the spherical surface of the large LCO particle 22. A ratio of a total weight of the large LLZO particles 24 and a weight of the large LCO particle 22 is 0.5%˜0.8%, and a ratio of a total weight of the small LLZO particles 26 and the weight of the large LCO particle 22 is 0.1%˜0.3%.

The large LLZO particles 24 and the small LLZO particles 26 are coated on the large LCO particle 22 by using a sintering. After the sintering, a vertical size of each of the large LLZO particles 24 and the small LLZO particles 26 is decreased, wherein the vertical size of the large LLZO particle 24 and the small LLZO particle 26 is a size on a direction perpendicular to the horizontal direction corresponding to the spherical surface of the large LCO particle 22. The horizontal size of each of the large LLZO particles 24 and the small LLZO particles 26 is increased. A volume of each of the large LLZO particles 24 and the small LLZO particles 26 remains unchanged.

Each of the large LLZO particles 24 and the small LLZO particles 26 is formed by a LLZO (lithium lanthanum zirconium oxide, Li₇La₃Zr₂O₁₂) or a LLZO doped with at least one metal. The LLZO doped with at least one metal may be a gallium (Ga)-doped LLZO (Li_{6.2}Ga_{0.8}La₃Zr₂O₁₂), an aluminum (Al)-doped LLZO or a barium (Ba)-doped LLZO.

Referring to FIG. 3, each of the large LLZO particles 24 forms a first protruded portion on a surface of the large LCO particle 22. A center of the first protruded portion is higher than a flat outer side of the first protruded portion. A cross section of the first protruded portion has a curved contour on the surface of the large LCO particle 22. A first LLZO interphase layer 25 is formed between a bottom of each of the large LLZO particles 24 and the large LCO particle 22. The first LLZO interphase layer 25 serves to provide better guiding channels for lithium ions and to protect the large LCO particle 22. An interphase thickness of the first LLZO interphase layer 25 is 2 nm˜12 nm.

The first LLZO interphase layer 25 is formed by a plurality of compounds containing “a LLZO or a LLZO doped with at least one metal”, cobalt-contained compounds and cobalt derivatives, wherein the cobalt is on an outer layer of the large LCO particle 22. The first LLZO interphase layer 25 includes a first oxygen-deficiency interface layer 251 and a first derivative layer 252 which are formed in an oxygen assisted sintering performed on the large LLZO particles 24 and the large LCO particle 22. The first oxygen-deficiency interface layer 251 is formed by a lanthanum zirconate (La₂Zr₂O₇) and a lanthanum (III) oxide (La₂O₃). The first derivative layer 252 is formed by a lithium phosphate (Li₃PO₄). A sum of a thickness of the first oxygen-deficiency interface layer 251 and a thickness of the first derivative layer 252 is 1 nm˜10 nm. The first LLZO interphase layer 25 facilitates a connection between the respective large LLZO particle 24 and the large LCO particle 22 to form a continuous interface. The first derivative layer 252 has an ability of conducting lithium (Li) ions, which is slightly inferior to that of the large LLZO particle 24. The first oxygen-deficiency interface layer 251 serves as an ion-conductive connection layer and serves to protect the large LCO particle 22. The first derivative layer 252 forms a thin film by deriving on a surface of the respective large LLZO particle 24, a surface of the respective small LLZO particle 26 and a surface of the large LCO particle 22.

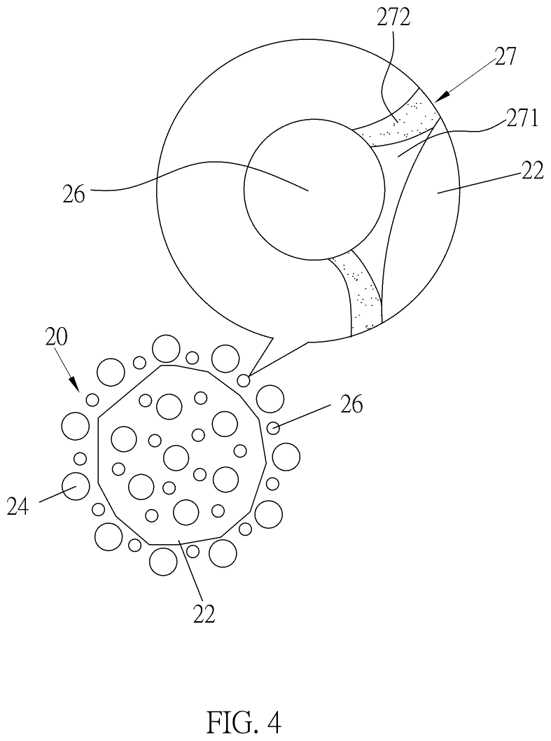

Referring to FIG. 4, each of the small LLZO particles 26 forms a second protruded portion on the surface of the large LCO particle 22. A center of the second protruded portion is higher than a flat outer side of the second protruded portion. A cross section of the second protruded portion has a curved contour on the surface of the large LCO particle 22. A second LLZO interphase layer 27 is formed between a bottom of each of the small LLZO particles 26 and the large LCO particle 22. The second LLZO interphase layer 27 serves to provide better guiding channels for lithium ions and to protect the large LCO particle 22. An interphase thickness of the second LLZO interphase layer 27 is 2 nm˜12 nm.

The second LLZO interphase layer 27 is formed by a plurality of compounds containing “a LLZO or a LLZO doped with at least one metal”, a cobalt-contained compounds and cobalt derivatives, wherein the cobalt is on an outer layer of the large LCO particle 22. The second LLZO interphase layer 27 includes a second oxygen-deficiency interface layer 271 and a second derivative layer 272 which are formed in an oxygen assisted sintering performed on the small LLZO particles 26 and the large LCO particle 22. The second oxygen-deficiency interface layer 271 is formed by a lanthanum zirconate (La₂Zr₂O₇) and a lanthanum (III) oxide (La₂O₃). The second derivative layer 272 is formed by a lithium phosphate (Li₃PO₄).

A sum of a thickness of the second oxygen-deficiency interface layer 271 and a thickness of the second derivative layer 272 is 1 nm˜10 nm. The second LLZO interphase layer 27 facilitates a connection between the respective small LLZO particle 26 and the large LCO particle 22 to form a continuous interface. The second derivative layer 272 has an ability of conducting lithium (Li) ions, which is slightly inferior to that of the small LLZO particle 26. The second oxygen-deficiency interface layer 271 serves as an ion-conductive connection layer for ion conduction and serves to protect the large LCO particle 22. The second derivative layer 272 forms a thin film by deriving on a surface of the respective large LLZO particle 24, a surface of the respective small LLZO particle 26 and a surface of the large LCO particle 22.

The small LLZO particles 26 serve to replace a part of the large LLZO particles 24, increase a surface coverage on the large LCO particle 22, and reduce the side reactions. The small LLZO particles 26 also are used as channels for conducting lithium ions, which reduces the cost of coating of the large LCO particle 22.

The surface of the large LCO particle 22 is coated with the large LLZO particles 24 and the small LLZO particles 26. The large LLZO particles 24 and the small LLZO particles 26 have a higher ion guiding capability than that of the large LCO particle 22 and do not easily produce a side reaction with lithium ions. Therefore, when the lithium ions pass through the positive electrode 100, conducting paths of the lithium ions are dispersed by the guiding of the large LLZO particles 24 and the small LLZO particles 26 distributed on the large LCO particle 22, which results in better conducting paths for the lithium ions and increases the battery performance.

Since that the large LLZO particles 24 cannot cover the large LCO particle 22 well and result in many gaps, it is necessary to fill the gaps between the large LLZO particles 24 by using the small LLZO particles 26, which can achieve a more robust process and a better surface coverage.

The first and second LLZO interphase layers 25, 27 form connections between the large LCO particle 22, the large LLZO particles 24 and the small LLZO particles 26. The more complete the covering of the large LLZO particles 24 and the small LLZO particles 26 on the large LCO particle 22, the less surface of the large LCO particle 22 is exposed, which reduces the rate and amount of side reactions with the electrolyte or colloidal materials and makes the positive electrode material more stable. The La₂Zr₂O₇ also has a capability of conducting lithium (Li) ions, which is not as good as that of the large LLZO particles 24 and the small LLZO particles 26, but it can be used as an ion-conducting layer to help conduct lithium ions from the large LCO particle to the large LLZO particles 24 and the small LLZO particles 26. The large LLZO particles 24 and the small LLZO particles 26 are used as fast tunnels for conducting the lithium ions, allowing the lithium ions from the large LCO particle 22 to migrate out and in quickly and efficiently through the first and second LLZO interphase layers 25, 27 to the large LLZO particles 24 and the small LLZO particles 26. The La₂Zr₂O₇ further has an inert in a ceramic compound, which reduces the side reaction between the positive electrode and the electrolyte. Especially at a high voltage (greater than 4.5V or even 4.9V), the first and second LLZO interphase layers 25, 27 provide a passivation and a protection for the large LCO particle 22.

Each of the large LLZO particles 24 and each of the small LLZO particles and the large LCO particle 22 have a crystal structure, which has a good stability and will not be easily released or dissociated, so it can increase the battery voltage.

Referring to FIG. 1, an outer surface of each of the composite LCO particle 20 is wrapped by a plurality of first carbon nanotubes 30. The composite LCO particle 20 is covered by the first carbon nanotubes 30 to form the positive particle 200.

The first carbon nanotubes 30 include a plurality of short chain carbon nanotubes 32 and a plurality of long chain carbon nanotubes 34. A length of each of the short chain carbon nanotubes 32 is 0.5 μm to 3 μm. A length of each of the long chain carbon nanotubes 34 is 8 μm to 12 μm. A ratio of a total weight of the short chain carbon nanotubes 32 and a total weight of the long chain carbon nanotubes 34 is 5:2. A ratio of a total weight of the first carbon nanotubes 30 and a total weight of the large LCO particle 22 is 0.01%˜0.5%.

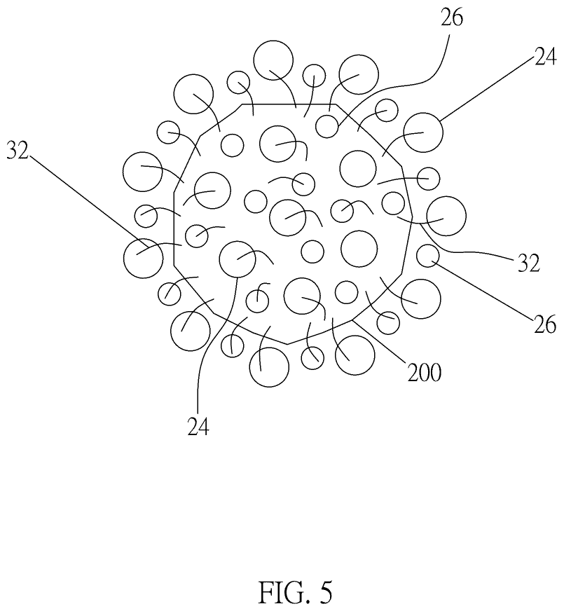

Referring to FIG. 5, each of the short chain carbon nanotubes 32 is connected across between the respective large LLZO particle 24 and the large LCO particle 22, or is connected across between the respective small LLZO particle 26 and the large LCO particle 22. The long chain carbon nanotubes 34 cover the composite LCO particle 20 including the short chain carbon nanotubes 32 to enhance a structural strength of the composite LCO particle 20. A carbon nanotube is a very good conductive material. The composite LCO particle 20 covered by the first carbon nanotubes 30 forms a hairball-like structure (as shown in FIG. 1).

The first carbon nanotubes 30 serve to increase the electrical conductance of the electron by forming a plurality of conductive bridges around the large LLZO particles 24 and the small LLZO particles for conducting the electron on the composite LCO particle 20. The first carbon nanotubes 30 have an extremely high electrical conductivity, so that lithium ions can pass through the first carbon nanotubes 30 and conduct between the large LLZO particles 24, the small LLZO particles 26 and the large LCO particle 22, which increase the electrical conductivity of the entire positive electrode 100.

Preferably, each of the large LLZO particles 24 and the small LLZO particles 26 is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

Preferably, each of the large LLZO particles 24 and the small LLZO particles 26 is formed by a Cuₐ, X_{b}-LLZO, which is a LLZO doped with copper (Cu) and a metal X, wherein X is selected from gallium (Ga), tantalum (Ta), strontium (Sr), barium (Ba) and aluminum (Al), and a>0 and b>0. Preferably, a+b=0.25˜0.8 and a>0.1. Doping the copper in the LLZO is technically difficult, but Cuₐ,X_{b}-LLZO can stabilize an overall structure of the composite LCO particle 20, smooth the channels for lithium ions, and increase a speed of the oxygen assisted sintering, which makes the cost more cheaper. It also reduces the producing of lithium carbonate (Li₂CO₃) when the large LLZO particles 24 and the small LLZO particles 26 is exposed to the air, which increases the surface stability of the large LLZO particles 24 and the small LLZO particles 26 during the sintering.

The advantages of the present invention are that the surface of the large LCO particles is coated with large and small LLZO particles and a interphase layer to form composite LCO particles, which enhances ionic conductivity and protection. Since electron transferring and ion transferring are interdependent, in order to solve the problem that the ceramic nature of the above oxides reduces a part of conductivity of electrons, the outer side of the composite LCO particles is further wrapped with an electron-conducting dielectric, which is a conductive network consisting of short chain and long chain carbon nanotubes with various lengths. The short chain carbon nanotubes provide capability of transferring short-range electron to conduct electrons for making lithium ion transfer easier, while the long chain carbon nanotubes provide capability of transferring the electron between various large and small LLZO particles, the composite LCO particles, and the other materials in the positive electrode substrate, so as to form a small electron transfer chain to promote transferring of ions, and thus improve transferring of electron and ion throughout the entire positive electrode. The wrapping of the carbon nanotubes and the large and small LLZO particles also makes lithium ions less likely to be blocked on the surface of the positive electrode due to poor transmission, and avoids to be combined with the electrolyte to form lithium consumption products such as SEI (Solid Electrolyte Interface). Therefore, it improves the overall lifespan of positive electrode, that is, the cycling performance. The positive electrode material of the present invention also achieves better multiplication performance with the better transfer chain of the lithium ion and electron. By the improving of the transferring of ion and electron in the positive electrode, the side reaction is decreased and the LLZO particles and the interphase layer provide more protection, so that the overall positive electrode is not easy to react with the electrolyte, and is also not easy to be affected by the side reaction after the electrolyte disintegrates and reacts with the positive electrode under a high voltage. As a result, the present invention improves the voltage resistance performance and enables it to be charged and discharged in a range of 4.7V˜4.9V, and reduces the behavior of high pressure oxygen releasing and gas producing of the positive electrode, which enhances the overall safety.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A LCO@oxide@CNT multicomposite cathode material, wherein the cathode material is a positive electrode material of a positive electrode inside a battery and the positive electrode material is a plurality of positive particles in a positive electrode used in a solid-state battery or semi-solid battery; and the oxide is a LLZO (lithium lanthanum zirconium oxide, Li₇La₃Zr₂O₁₂ or a LLZO doped with at least one metal; each of the positive particles comprising:
a composite LCO particle; the composite LCO particle including:
a large LCO (lithium cobalt oxide, LiCoO₂) particle which is a cube having an irregular shape; and
a plurality of large LLZO particles and a plurality of small LLZO particles coated on a surface of the large LCO particle; each of the large LLZO particles and the small LLZO particles being formed by a LLZO (lithium lanthanum zirconium oxide, Li₇La₃Zr₂O₁₂) or a LLZO doped with at least one metal;
wherein each of the large LLZO particles forms a first protruded portion on a surface of the large LCO particle; a center of the first protruded portion is higher than a flat outer side of the first protruded portion; a first LLZO interphase layer is formed between a bottom of each of the large LLZO particles and the large LCO particle; the first LLZO interphase layer serves to provide guiding channels for lithium ions and to provide a protection for the large LCO particle;
wherein each of the small LLZO particles forms a second protruded portion on the surface of the large LCO particle; a center of the second protruded portion is higher than a flat outer side of the second protruded portion; a second LLZO interphase layer is formed between a bottom of each of the small LLZO particles and the large LCO particle; the second LLZO interphase layer serves to provide guiding channels for lithium ions and to provide a protection for the large LCO particle;
wherein the large LLZO particles and the small LLZO particles have a higher ion guiding capability than that of the large LCO particle and do not easily produce a side reaction with lithium ions; when the lithium ions pass through the positive electrode, conducting paths of the lithium ions are dispersed by the guiding of the large LLZO particles and the small LLZO particles distributed on the large LCO particle; and
wherein each of the large LLZO particles and each of the small LLZO particles and the large LCO particle have a crystal structure, which has a good stability and will not be easily released or dissociated, increasing the battery voltage.

2. The LCO@oxide@CNT multicomposite cathode material as claimed in claim 1, wherein a size of the large LCO particle is 10 μm to 15 μm.

3. The LCO@oxide@CNT multicomposite cathode material as claimed in claim 1, wherein a horizontal size of each of the large LLZO particles is 100 nm˜280 nm, which is a size of the large LLZO particle on a horizontal direction corresponding to a spherical surface of the large LCO particle; and a horizontal size of each of the small LLZO particles is 50 nm˜100 nm, which is a size of the small LLZO particle on the horizontal direction corresponding to the spherical surface of the large LCO particle.

4. The LCO@oxide@CNT multicomposite cathode material as claimed in claim 1, wherein a ratio of a total weight of the large LLZO particles and a weight of the large LCO particle is 0.5%˜0.8%; and a ratio of a total weight of the small LLZO particles and the weight of the large LCO particle is 0.1%˜0.3%.

5. The LCO@oxide@CNT multicomposite cathode material as claimed in claim 1, wherein an interphase thickness of the first LLZO interphase layer is 2 nm˜12 nm; and an interphase thickness of the second LLZO interphase layer is 2 nm˜12 nm.

6. The LCO@oxide@CNT multicomposite cathode material as claimed in claim 1, wherein each of the first LLZO interphase layer and the second LLZO interphase layer is formed by a plurality of compounds containing a LLZO or a LLZO doped with at least one metal, cobalt-contained compounds and cobalt derivatives, wherein the cobalt is on an outer layer of the large LCO particle; and the first LLZO interphase layer and the second LLZO interphase layer serve to provide guiding channels for lithium ions.

7. The LCO@oxide@CNT multicomposite cathode material as claimed in claim 1, wherein the first LLZO interphase layer includes a first oxygen-deficiency interface layer and a first derivative layer which are formed in an oxygen assisted sintering performed on the large LLZO particles and the large LCO particle; the first oxygen-deficiency interface layer is formed by a lanthanum zirconate (La₂Zr₂O₇) and a lanthanum (III) oxide (La₂O₃); the first derivative layer is formed by a lithium phosphate (Li₃PO₄); a sum of a thickness of the first oxygen-deficiency interface layer and a thickness of the first derivative layer is 1 nm˜10 nm; the first derivative layer has an ability of conducting lithium (Li) ions; the first oxygen-deficiency interface layer serves as an ion-conductive connection layer and serve to protect the large LCO particle; the first derivative layer forms a thin film by deriving on a surface of the respective large LLZO particle, a surface of the respective small LLZO particle and a surface of the large LCO particle; and
wherein the second LLZO interphase layer includes a second oxygen-deficiency interface layer and a second derivative layer which are formed in an oxygen assisted sintering performed on the small LLZO particles and the large LCO particle; the second oxygen-deficiency interface layer is formed by a lanthanum zirconate (La₂Zr₂O₇) and a lanthanum (III) oxide (La₂O₃); the second derivative layer is formed by a lithium phosphate (Li₃PO₄); a sum of a thickness of the second oxygen-deficiency interface layer and a thickness of the second derivative layer is 1 nm˜10 nm; the second derivative layer has an ability of conducting lithium (Li) ions, which is slightly inferior to that of the small LLZO particle; the second oxygen-deficiency interface layer serves as an ion-conductive connection layer for ion conduction and serves to protect the large LCO particle; and the second derivative layer forms a thin film by deriving on a surface of the respective large LLZO particle, a surface of the respective small LLZO particle and a surface of the large LCO particle.

8. The LCO@oxide@CNT multicomposite cathode material as claimed in claim 1, wherein an outer surface of each of the composite LCO particle is wrapped by a plurality of first carbon nanotubes; the composite LCO particle is covered by the first carbon nanotubes to form the positive particle.

9. The LCO@oxide@CNT multicomposite cathode material as claimed in claim 8, wherein the first carbon nanotubes include a plurality of short chain carbon nanotubes and a plurality of long chain carbon nanotubes; a length of each of the short chain carbon nanotubes is 0.5 μm to 3 μm; a length of each of the long chain carbon nanotubes is 8 μm to 12 μm; and
wherein each of the short chain carbon nanotubes serves to be connected across between the respective large LLZO particle and the large LCO particle, or to be connected across between the respective small LLZO particle and the large LCO particle; the long chain carbon nanotubes serve to cover the composite LCO particle including the short chain carbon nanotubes.

10. The LCO@oxide@CNT multicomposite cathode material as claimed in claim 9, wherein a ratio of a total weight of the short chain carbon nanotubes and a total weight of the long chain carbon nanotubes is 5:2; and a ratio of a total weight of the first carbon nanotubes and a total weight of the large LCO particle is 0.01%˜0.5%.

11. The LCO@oxide@CNT multicomposite cathode material as claimed in claim 9, wherein each of the large LLZO particles and the small LLZO particles is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

12. The LCO@oxide@CNT multicomposite cathode material as claimed in claim 1, wherein each of the large LLZO particles and the small LLZO particles is formed by a Cuₐ,X_{b}-LLZO, which is a LLZO doped with copper (Cu) and a metal X, wherein X is selected from gallium (Ga), tantalum (Ta), strontium (Sr), barium (Ba) and aluminum (Al), and a>0 and b>0; the Cua, Xb-LLZO serves to stabilize an structure of the composite LCO particle, smooth channels for lithium ions, and increase a speed of the oxygen assisted sintering; the Cuₐ,X_{b}-LLZO also serves to reduce producing of lithium carbonate (Li₂CO₃) when the large LLZO particles and the small LLZO particles is exposed to the air, which increases the surface stability of the large LLZO particles and the small LLZO particles.

13. The LCO@oxide@CNT multicomposite cathode material as claimed in claim 12, wherein a+b=0.25˜0.8 and a>0.1.

14. The LCO@oxide@CNT multicomposite cathode material as claimed in claim 1, wherein a cross section of the first protruded portion has a curved contour on the surface of the large LCO particle; and a cross section of the second protruded portion has a curved contour on the surface of the large LCO particle.
